(19) United States
(12) Patent Application Publication
(10) Pub. No.: US 2011/0267007 A1
(43) Pub. Date: Nov. 3, 2011

(54) DISCHARGE METHOD FOR A BATTERY PACK

(75) Inventors: TAI-HUNG CHEN, HSINCHU COUNTY (TW); KUO-CHANG HUANG, HSINCHU COUNTY (TW); CHU-LUN YANG, TAINAN CITY (TW)

(73) Assignee: SIMPLO TECHNOLOGY CO., LTD., HSINCHU COUNTY (TW)

(21) Appl. No.: 13/090,315

(22) Filed: Apr. 20, 2011

(30) Foreign Application Priority Data
Apr. 30, 2010 (TW) 99113917

(51) Int. Cl. H02J 7/04; H02J 7/00

(52) U.S. Cl. 320/126; 320/135

(57) ABSTRACT

The present invention provides a discharge method for a hybrid battery pack to thereby extend its usage life. The discharge method determines which one of the battery sets installed in a hybrid battery pack should be held active to discharge electricity according to their parameters of battery state of health (SOH), wherein at least two of the battery sets are different in cell type. Accordingly, the method can optimize the discharging efficiency of the hybrid battery pack and then extend its usage life.

### BACKGROUND OF THE INVENTION

1. Field of the Invention

The present invention relates to a discharge method for a battery pack, especially to a discharge method for a hybrid battery pack.

2. Description of Related Art

In order to realize the requirement of the outward appearance and usage time of an electronic apparatus, a battery designer usually integrates two or more types of battery cells such as a lithium polymer cell and a lithium cell or a nickel-metal hydride cell to produce a battery pack for the electronic apparatus.

However, while the difference of discharging characteristic between battery cells of the same type is negligible, the difference between battery cells of different types is too influential to be ignored. Hence, integrating different battery cells in type to produce a battery pack will seriously deteriorate its performance and usage life. This is mainly due to the inadequate discharge method at present, which determines which type of the battery cells should be held active to discharge electricity according to their charging/discharging cycle counts.

A prior art is disclosed in the U.S. Pat. No. 7,494,729, which describes a battery pack including two types of battery sets. Each battery set is composed of a plurality of battery cells. A CPU detects the charging/discharging cycle counts of the battery sets and thereby determines which battery set should be held active to discharge electricity. For example, if the charging/discharging cycle count of the battery set M is more than three greater than the charging/discharging cycle count of the battery set N, the CPU will hold the battery set N active to discharge electricity and keep the battery set M inactive to remain standby. Similarly, if the charging/discharging cycle counts of the battery set N is more than three greater than the charging/discharging cycle counts of the battery set M, the CPU will hold the battery set M active and keep the battery set N inactive.

Please refer to FIG. 1 which illustrates the discharge property curves of different battery cells and a hybrid battery having them. As shown in FIG. 1, the longitudinal axis represents the state of health (SOH) of a battery, wherein the SOH is a percentage of the full charge capacity (FCC) divided by the design capacity (DC), and the transverse axis represents the charging/discharging cycle count of a battery. The curve “a” stands for the SOH of a lithium polymer cell in view of its cycle count; the curve “b” stands for the SOH of a lithium cell of model 18650 in view of its cycle count; and the curve “c” stands for the SOH of a hybrid battery including the lithium polymer cell and the lithium cell of model 18650 in view of its cycle count.

According to the curve “b” of FIG. 1, the SOH of the lithium cell of model 18650 deteriorates sharply with its charging/discharging cycle count increasing. More specifically, the SOH of the lithium cell of model 18550 is lower than 65% after its charging/discharging cycle count exceeds 420; meanwhile, the SOH of the lithium polymer cell still remains 98% as shown by the curve “a”. Unfortunately, at the same time the SOH of the hybrid battery having the lithium polymer cell and lithium cell of model 18650 is only about 80% due to the encumbrance of the lithium cell of model 18650 as illustrated by the curve “c”, which teaches that the cell of relatively bad discharge properties will be a burden on the whole performance of the hybrid battery.

### SUMMARY OF THE INVENTION

The present invention discloses a discharging method for a hybrid battery pack to thereby optimize its usage efficiency and life. The method determines which one of the battery sets installed in the hybrid battery pack should be held active to discharge electricity preferentially, so as to improve the usage efficiency and life of the hybrid battery pack.

An embodiment of the present invention discloses a discharging method for a hybrid battery pack according to the states of health (SOH) of the different battery sets installed in the hybrid battery pack. More specifically, the method will hold the battery set with higher SOH active to discharge electricity preferentially so that the battery set with higher SOH will be used more frequently than the battery set with lower SOH. Therefore, the usage life of the hybrid battery pack can be extended.

Another embodiment of the present invention discloses a method for a battery pack to automatically discharge electricity if its capacity is higher than a first predetermined threshold for a preset duration, and stop the self-discharging if its capacity is lower than a second predetermined threshold. Hence, the usage life of the battery pack can be extended.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing the discharge property curve of a conventional hybrid battery.

FIG. 2 illustrates a hybrid battery pack using the discharge method of the present invention.

FIG. 3A and FIG. 3B show the flow chart of the discharge method of the present invention.

FIG. 4 is a diagram showing the discharge property curve of the hybrid battery pack of FIG. 2.

FIG. 5 shows the flow chart of the self-discharging method of the present invention.

FIG. 6 illustrates a battery device using the self-discharging method of the present invention.

FIG. 7 shows another battery device using the self-discharging method of the present invention.

FIG. 8 shows a further battery device using the self-discharging method of the present invention.

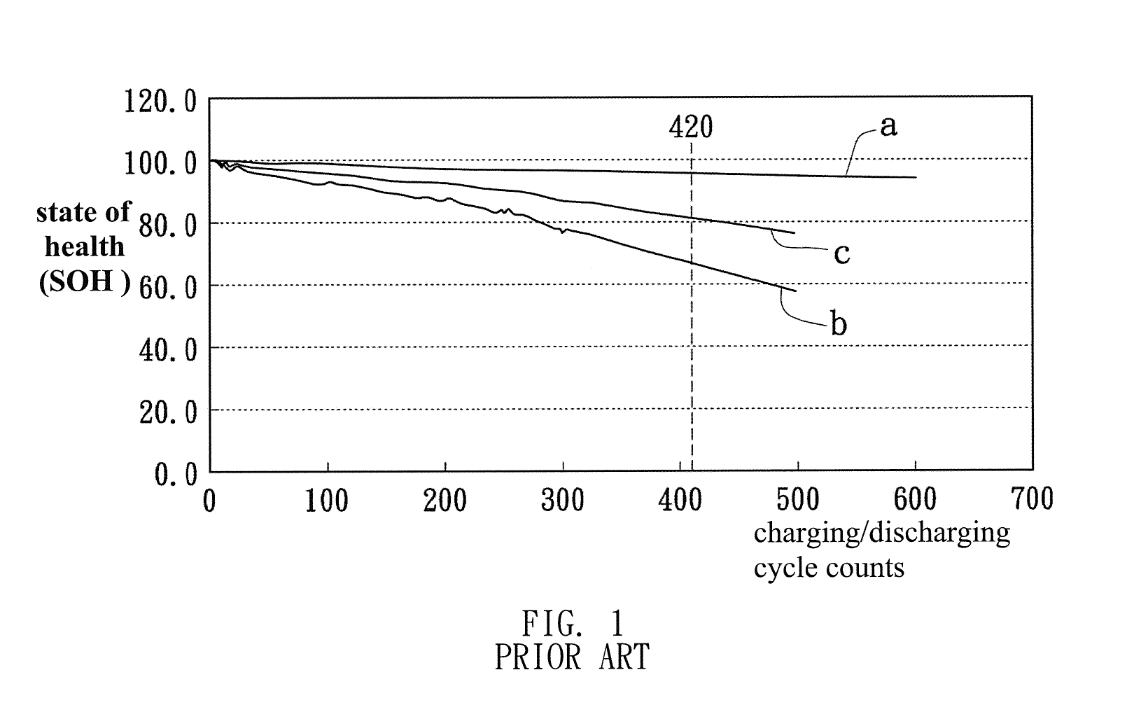

### DETAILED DESCRIPTION OF THE PREFERRED EMBODIMENTS

The first embodiment of the present invention discloses a method for a battery set among a plurality of battery sets installed in a hybrid battery pack to discharge electricity according to the capacities of the plurality of battery sets. To be more specific, the battery set with higher value of SOH (state of health) will be held active to discharge electricity preferentially while the battery set of lower value of SOH will be held inactive to remain standby. Please note that in this embodiment, the state of health (SOH) is the percentage of the full charge capacity (FCC) divided by the design capacity (DC).

Please also note that in order to describe the present invention in an understandable and clear way, the hybrid battery pack of each embodiment in this specification is illustrated with two types of battery sets installed in it, wherein one of the battery sets is composed of one or more lithium polymer cells while the other one is composed of one or more lithium cells of model 18650. However, this shouldn't be the limitation to the present invention. An artisan of ordinary skill in the art will appreciate how to make an equivalent change to the present invention after reading the disclosure of this specification.

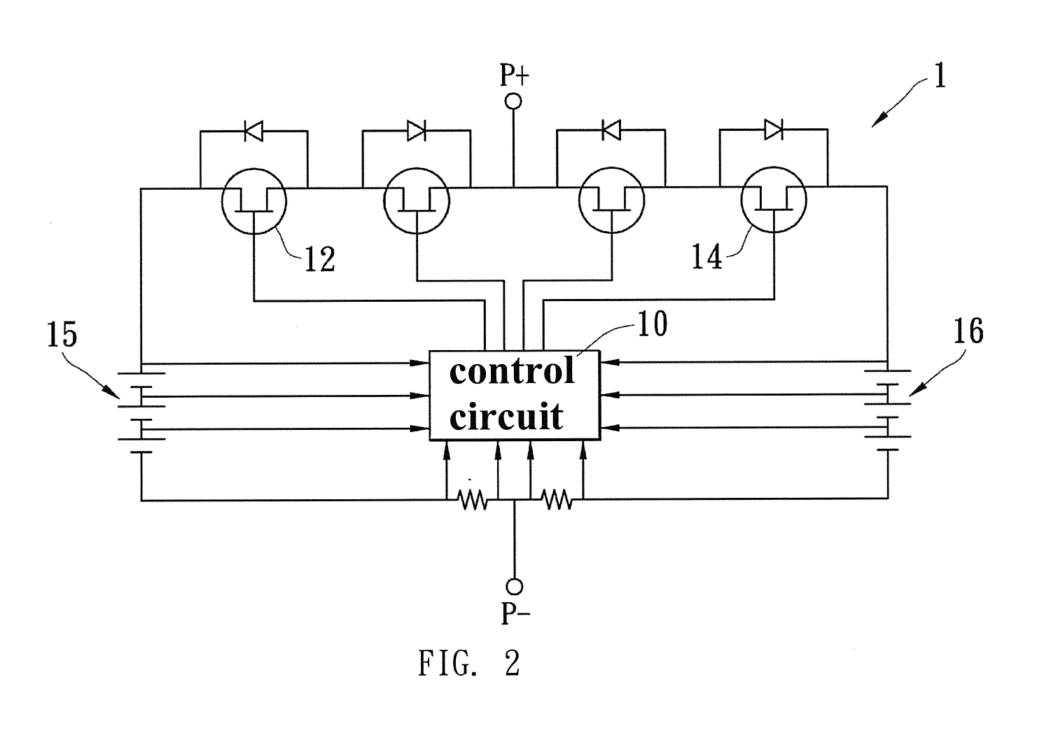

Please refer to FIG. 2 which shows a hybrid battery pack functioning in accordance with the discharge method of the first embodiment. As shown in FIG. 2, the hybrid battery pack 1 designed for an electronic apparatus can be charged or discharge electricity through the nodes P+ and P−. The electronic apparatus could be a digital camera, a mobile phone, a personal digital assistant, a notebook, a multimedia device, an electrical vehicle, or any product driven by the hybrid battery pack. The hybrid battery pack could be installed in the electronic apparatus with a detachable or fixed way.

The hybrid battery pack 1 comprises two or more battery sets connected in parallel. Each of the battery sets is composed of a plurality of battery cells. In this embodiments, the hybrid battery pack 1 comprises a control circuit 10, a first switch 12, a second switch 14, a first battery set 15 and a second battery set 16, wherein the first and second battery sets 15, 16 are different in cell type or the same but with substantially different discharge properties. The cell type could be but not limited to lithium polymer cell, lithium cell or nickel-metal hydride cell (NiMH cell).

The control circuit 10 couples to the first battery set 15 and the second battery set 16 to monitor and control their discharge states. The control circuit 10 controls the on/off states of the first and second switches 12, 14, so as to discharge the electricity of the first and second battery sets 15, 16 in different time.

Please refer to FIG. 2 again. The control circuit 10 receives the voltage and current information of the first and second battery sets 15, 16 and accordingly takes down their present FCC (full charge capacity) values and does calculation in accordance with their FCC and DC (design capacity) values, so as to obtain a first parameter and a second parameter representing or corresponding to the values of SOH (state of health) of the first and second battery sets 15, 16, respectively. Please note that the control circuit 10 includes a storage unit to store the received information and/or the calculation results. Since the storage unit is well-known in this filed, the detail illustration is omitted here.

Besides, when both of the first and second battery sets 15, 16 are ready for discharging electricity, the control circuit 10 executes the discharge method of the present invention to determine which battery set should be held active to discharge electricity preferentially according to their SOH values. In this embodiment, if the first battery set 15 has a greater SOH value, the control circuit 10 has the aforementioned switch 12 enter the on state to allow the first battery set 15 providing its electricity for the electronic apparatus first; if the second battery set 16 has a greater SOH value, the control circuit 10 makes the switch 14 enter the on state instead to allow the second battery set 16 discharging electricity preferentially.

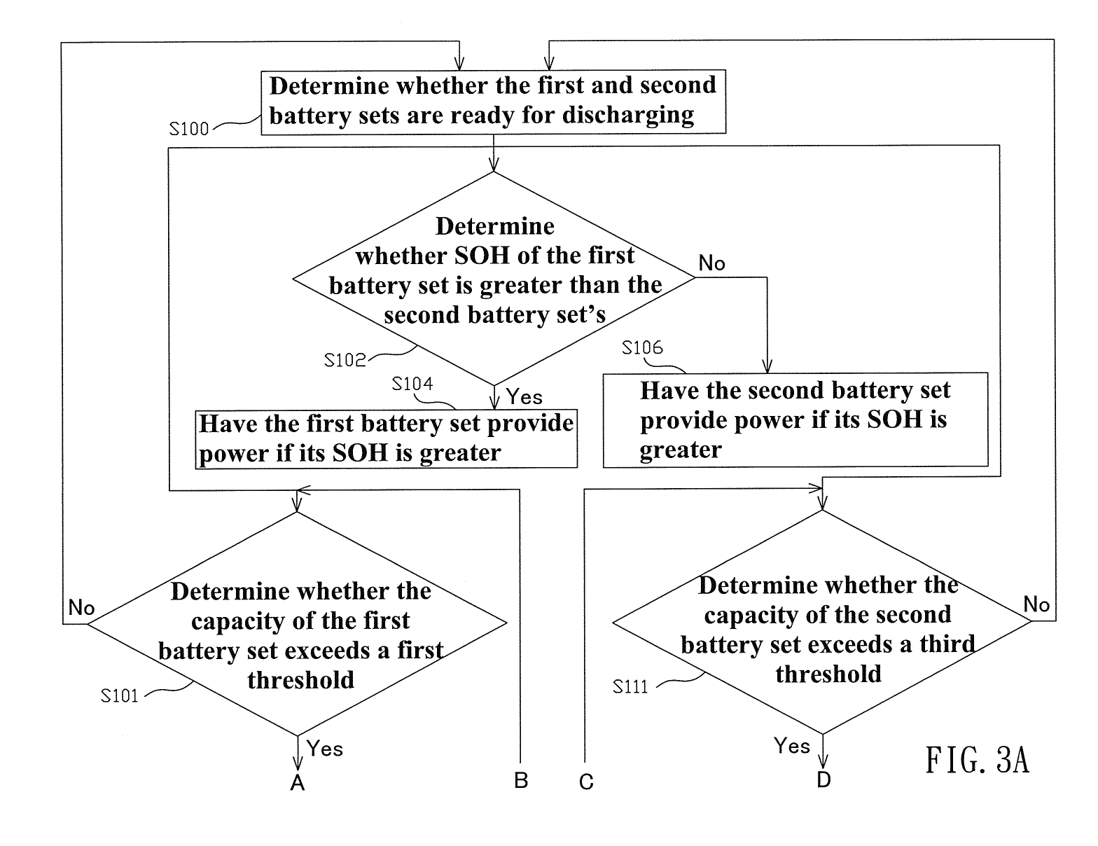

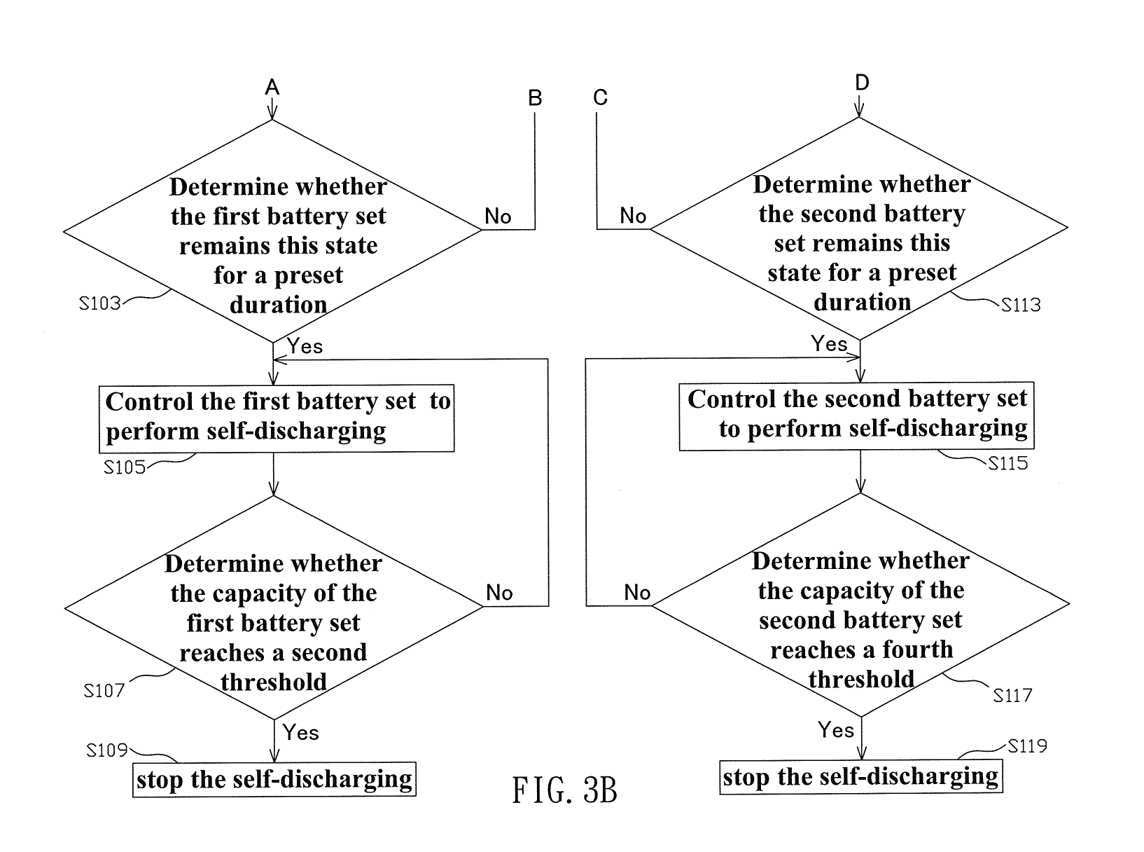

Please refer to FIG. 3A and FIG. 3B which show the flow chart of an exemplary discharge method of the present invention. This exemplary discharge method that can be applied to the hybrid battery pack of FIG. 2 teaches how to determine which one of a plurality of battery sets connected in parallel should provide power first. After the control circuit 10 of FIG. 2 received the request of providing power, it can decide to use which one of the battery sets in accordance with the method as shown in FIG. 3A and FIG. 3B.

The above-mentioned method comprises the following steps: determining whether the first and second battery sets are ready for discharging electricity (S100) through the control circuit 10 reading the first and second parameters which represent the SOH values of the first and second battery sets 15, 16 respectively; having the control circuit 10 determine whether the first parameter is greater than the second parameter (S102); if the first parameter is greater than the second parameter, having the control circuit 10 turn on the switch 12 to use the first battery set 15 to provide power first (S104); and if the first parameter is less than the second parameter, having the control circuit 10 turn on the switch 14 to use the second batter set 16 to discharge its electricity preferentially (S106).

Please refer to FIG. 3A and FIG. 3B again. In order to prevent the first battery set 15 from staying fully charged for too long, which may cut down its usage life, the discharge method of the present invention further comprises the steps of having the control circuit 10 determine whether the capacity of the first battery set 15 exceeds a first threshold (S101); if the capacity of the first battery set 15 reaches the first threshold, having the control circuit 10 further determine whether the first battery set 15 remains this state for a preset duration (S103); and if the first battery set 15 has its capacity greater than the first threshold for at least the preset duration, having the control circuit 10 control the first battery set 15 to perform self-discharging (S105).

After executing the step S105, the method further has the control circuit 10 determine whether the capacity of the first battery set 15 is equal to or less than a second threshold (S107) and accordingly makes it stop the self-discharging if the capacity of the first battery set 15 is less than the second threshold (S109).

Similarly, in order to prevent the second battery set 16 from staying fully charged for too long, which may harm its usage life, the discharge method of the present invention has the control circuit 10 execute the following steps: determining whether the capacity of the second battery set 16 exceeds a third threshold (S111); if the capacity of the second battery set 16 reaches the third threshold, determining whether the second battery set 16 remains this state for a preset duration (S113); and if the second battery set 15 keeps its capacity greater than the third threshold for at least the preset duration, controlling the second battery set 16 to perform self-discharging (S115).

After executing the step S115, the method further has the control circuit 10 determine whether the capacity of the second battery set 16 is equal to or less than a fourth threshold (S117) and thereby ceases its self-discharging through the control circuit 10 if the capacity is less than the fourth threshold (S119).

Therefore, through the aforementioned self-discharging, the first and second battery sets 15, 16 can automatically discharge electricity till the second and fourth thresholds are satisfied respectively, so that their usage life can be extended. In this embodiment, the second and fourth thresholds are equal to or larger than the cease-charging voltages of the battery sets (i.e. the voltages indicating that the battery sets are fully charged), respectively.

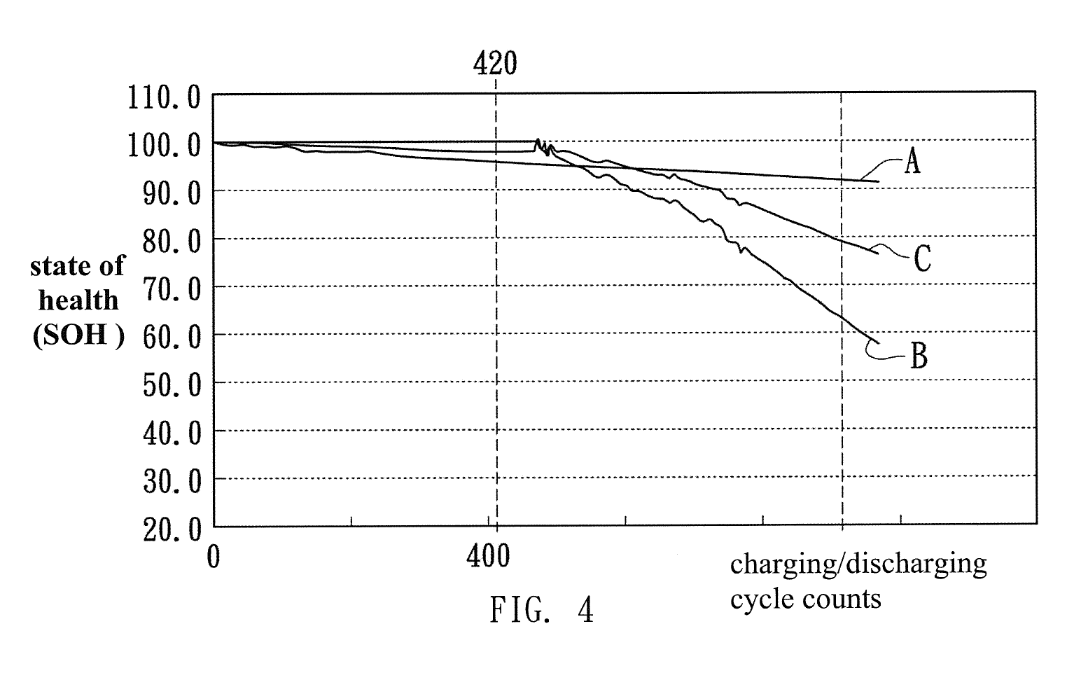

Please refer to FIGS. 2 and 4, wherein FIG. 4 shows the discharge property curve of the hybrid battery pack of the aforementioned first embodiment of the present invention. As shown in FIG. 4, the longitudinal axis represents the state of health (SOH) of a battery; the transverse axis represents the charging/discharging cycle count of a battery set/pack; the curve “a” stands for the SOH of a battery set of lithium polymer cell in view of its cycle count; the curve “b” stands for the SOH of a battery set of lithium cell of model 18650 in view of its cycle count; and the curve “c” stands for the SOH of a hybrid battery including the two battery sets in view its cycle count.

Please refer to FIG. 4 again. According to the curves “a” and “b”, the hybrid battery pack 1 preferentially uses the battery set of lithium polymer cell with better SOH to provide power. After the cycle count of the battery set of lithium polymer cell exceeds 420 times, the hybrid battery pack 1 then uses the battery set of lithium cell of model 18650 to provide electricity because its SOH is now better than the SOH of the battery set of lithium polymer cell. Thus, as shown by the curve “c”, the hybrid battery pack 1 can keep its SOH above 80% after its cycle count exceeds 800 times. Accordingly, the discharge method of the present invention can improve the discharge efficiency of a hybrid battery pack and extend its usage life.

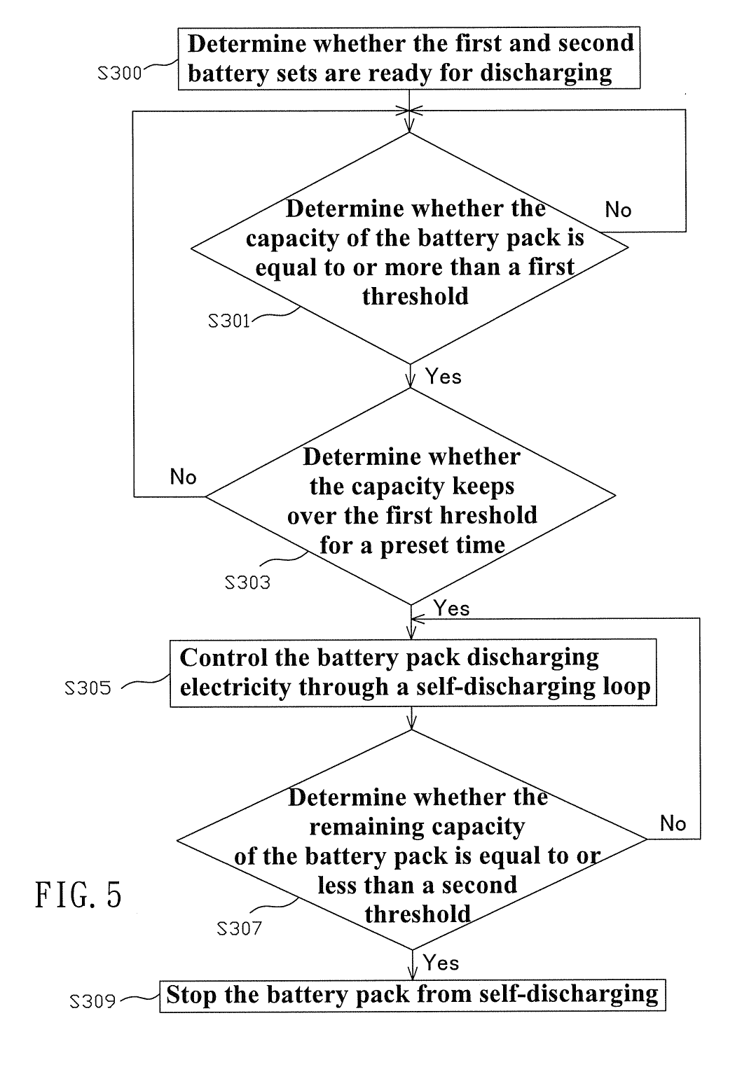

Please refer to FIG. 5 which illustrates the flow chart of a self-discharging method of the present invention. The self-discharging method is carried out by a control circuit (not shown in FIG. 5) to allow a battery pack (not shown in FIG. 5) executing self-discharging.

The self-discharging method of this embodiment comprises the following steps: determining whether the battery pack is ready for providing power (S300); having the control circuit determine whether the capacity of the battery pack is equal to or more than a first threshold (S301); if the capacity of the battery pack reaches the first threshold, having the control circuit determine whether the capacity keeps over the first threshold for a preset time (S303); if the capacity is equal to or more than the first threshold for at least the preset time, having the control circuit control the battery pack discharging electricity through a self-discharging loop (S305); during the battery pack executing the self-discharging, having the control circuit determine whether the remaining capacity of the battery pack is equal to or less than a second threshold (S307); and if the remaining capacity is equal to or less than the second threshold, having the control circuit stop the battery pack from self-discharging (S309).

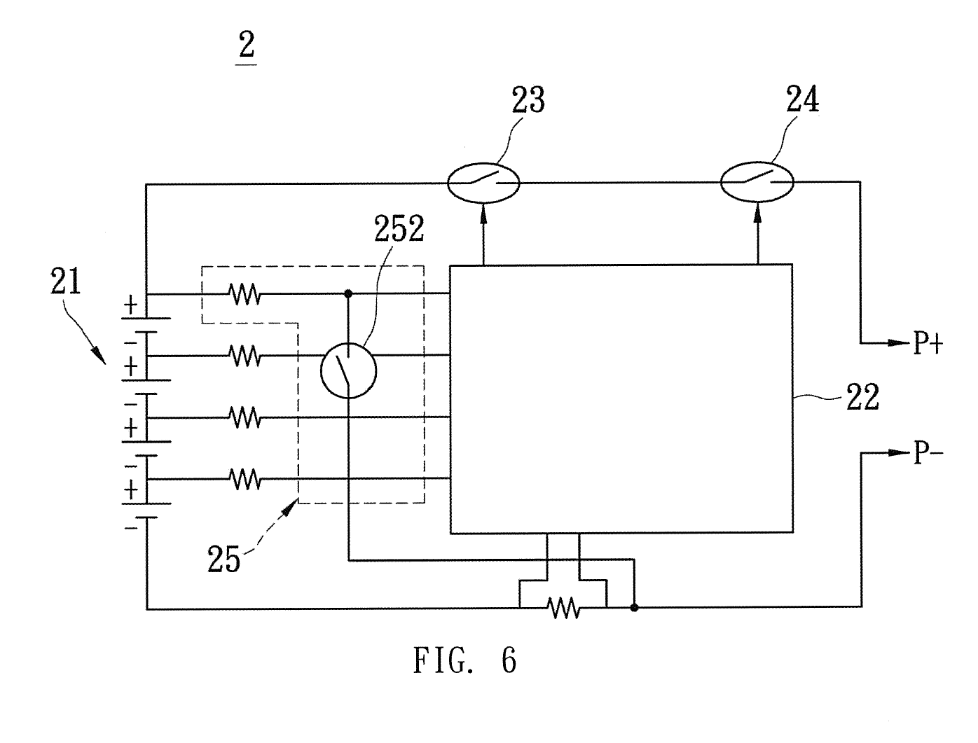

Please refer to FIGS. 5 and 6, wherein FIG. 6 illustrates a battery device using the self-discharging method of FIG. 5. As shown in FIG. 6, the battery device 2 comprises a battery set 21, a control circuit 22, a charging switch 23, a discharging switch 24 and a self-discharging loop 25. The battery set 21 is composed of a plurality of battery cells. The control circuit 22 couples to the battery set 21 for monitoring and controlling the charging and discharging states of the battery set 21. The charging and discharging switches 23, 24 couple to the control circuit 22 and change their on/off states according to the control of the control circuit 22, and thereby allow the battery set 21 executing or stopping self-discharging.

Please refer to FIG. 6 again. The control circuit 22 accesses the voltage and current information of the battery set 21 and accordingly determines whether the capacity of the battery set 21 is equal to or higher than a first threshold for a preset time. Consequently, if the capacity keeps higher than the first threshold for at least the preset time, the control circuit 22 will turn on a switch 252 of the self-discharging loop 25 to allow the battery set 21 discharging electricity till its capacity falls under or equals to a second threshold which is no less than the cease-charging voltage of the battery set 21 in this embodiment. Therefore, through the above-mentioned method, the usage life of a battery device can be guaranteed.

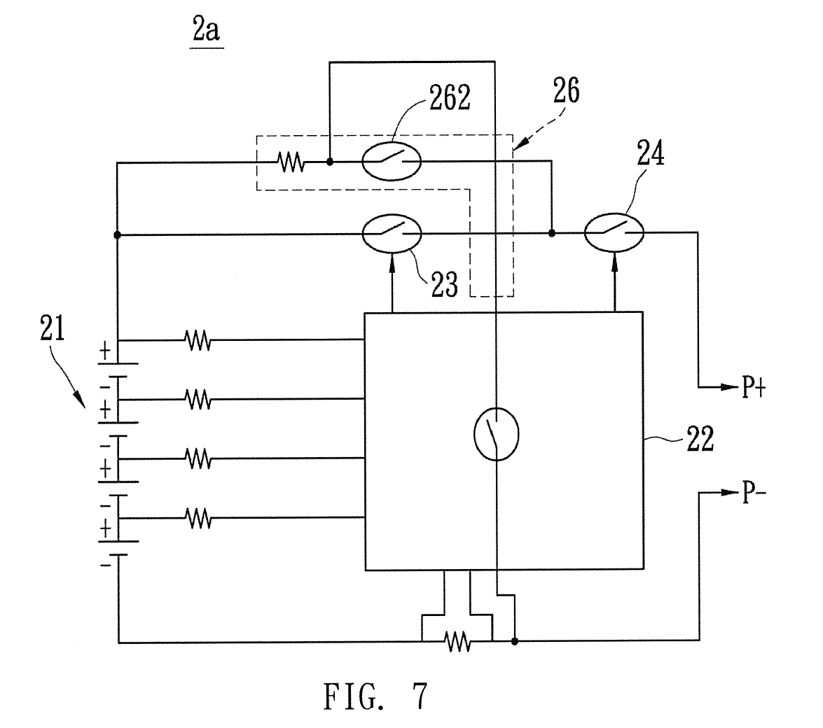

Please refer to FIGS. 5, 6 and 7, wherein FIG. 7 proposes another battery device using the self-discharging method of FIG. 5. The difference between the battery devices of FIGS. 6 and 7 is that the battery device 2a of FIG. 7 lacks a switch like the switch 252 of FIG. 6 but reforms a conventional pre-charging circuit to make it become a self-discharging loop 26 which couples to the battery set 21 and the control circuit 22 and allows the battery set 21 to perform self-discharging according to the control of the control circuit 22.

Please refer to FIG. 7 again. If the capacity of the battery set 21 is equal to or more than the first threshold for at least the preset time, the control circuit 22 will turn on an external switch 262 of the self-discharging loop 26 to allow the battery set 21 discharging electricity through the self-discharging loop 26 till reaching the second threshold. The external switch 262 changes its on/off state for providing the self-discharging or pre-charging function. More specifically, when turning on the external switch 262, the loop 26 functions as a self-discharging path for the battery set 21; when turning off the external switch 262, the loop 26 functions as a pre-charging path for the battery set 21.

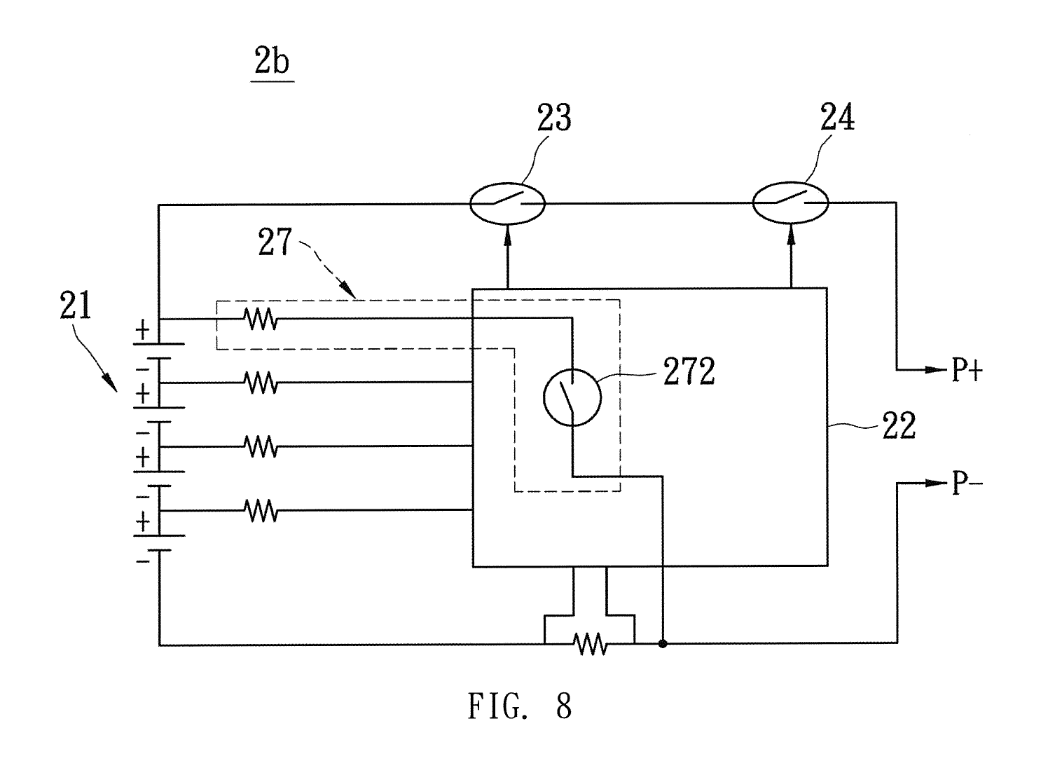

Please refer to FIGS. 5, 6 and 8, wherein FIG. 8 brings up a further battery device using the self-discharging method of FIG. 5. The difference between the battery device 2b of FIG. 8 and the battery device of FIG. 6 is that the battery device 2b lacks a switch like the switch 252 of FIG. 6 but reforms a conventional voltage-detection circuit to make it become a self-discharging loop 27 which couples to the battery set 21 and the control circuit 22 and allows the battery set 21 to perform self-discharging according to the control of the control circuit 22.

Please refer to FIG. 8 again. If the capacity of the battery set 21 is equal to or higher than the first threshold for at least the preset time, the control circuit 22 will turn on an external switch 272 of the self-discharging loop 27 to allow the battery set 21 discharging electricity through the self-discharging loop 27 till satisfying the second threshold. The external switch 272 changes its on/off state for providing the self-discharging or voltage-detection function. To be more specific, when turning on the external switch 272, the loop 27 functions as a self-discharging path for the battery set 21; when turning off the external switch 272, the loop 27 functions as a voltage-detection path for the battery set 21.

To sum up, the present invention disclosed a discharge method for determining the discharge priority of battery sets in a battery pack and a self-discharging method for preventing a battery device from staying the fully charged state for too long, which therefore improve the usage lives. Please note that an artisan of ordinary skill in the art will appreciate how to combine the discharge method with the self-discharging method according to the disclosure of this specification without undue experiment.

Finally, please note that the aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A discharge method for a hybrid battery apparatus, which is executed by a control circuit to use a first battery set or a second battery set to provide power for a load, the method comprising:
using the control circuit to obtain a first parameter of the first battery set according to a first full charge capacity and a first design capacity of the first battery set;
using the control circuit to obtain a second parameter of the second battery set according to a second full charge capacity and a second design capacity of the second battery set;
determining the relation between the first and second parameters to obtain a result;
if the result indicates that the first parameter is equal to or higher than the second parameter, making the first battery set provide power for the load through the control of the control circuit; and
if the result indicates that the first parameter is less than the second parameter, making the second battery set provide power for the load through the control of the control circuit,
wherein the first and second battery sets provide power in different time under the control of the control circuit.

2. The discharge method of claim 1, wherein the first and second battery sets are electrically connected in parallel.

3. The discharge method of claim 2, wherein the first and second battery sets are composed of different cells respectively.

4. The discharge method of claim 2, wherein the first parameter and/or the second parameter represents a percentage of the full charge capacity divided by the design capacity.

5. The discharge method of claim 1, further comprising:
having the control circuit determine whether the capacity of the first battery set is equal to or over a first threshold;
if the control circuit determines that the capacity of the first battery set is equal to or over the first threshold, having the control circuit determine whether the capacity of the first batter set stays higher than the first threshold for a first preset time;
if the capacity of the first battery set remains equal to or higher than the first threshold for at least the first preset time, having the control circuit control the first battery set executing self-discharging;
during the first battery set executing self-discharging, having the control circuit determine whether the capacity of the first battery set is equal to or under a second threshold; and
if the capacity of the first battery set is equal to or under the second threshold, having the control circuit stop the first battery set from self-discharging.

6. The discharge method of claim 5, further comprising:
having the control circuit determine whether the capacity of the second battery set is equal to or over a third threshold;
if the control circuit determines that the capacity of the second battery set is equal to or over the third threshold, having the control circuit determine whether the capacity of the second battery set stays higher than the third threshold for a second preset time;
if the capacity of the second battery set remains equal to or higher than the third threshold for at least the second preset time, having the control circuit control the second battery set executing self-discharging;
during the second battery set executing self-discharging, having the control circuit determine whether the capacity of the second battery set is equal to or under a fourth threshold; and
if the capacity of the second battery set is equal to or under the fourth threshold, having the control circuit stop the second battery set from self-discharging.

7. A self-discharging method for a battery device, which is executed by a control circuit to allow the battery device to perform self-discharging through a self-discharging loop, the method comprising:
having the control circuit determine whether the capacity of the battery device is equal to or above a first threshold;
if the control circuit determines that the capacity of the battery device is equal to or above the first threshold, having the control circuit determine whether the capacity of the first batter set stays higher than the first threshold for a preset time;
if the capacity of the battery device remains equal to or higher than the first threshold for at least the preset time, having the control circuit control the battery device executing self-discharging through the self-discharging loop;
during the battery device executing self-discharging, having the control circuit determine whether the capacity of the battery device is equal to or under a second threshold; and
if the capacity of the battery device is equal to or under the second threshold, having the control circuit stop the battery device from self-discharging by electrically breaking off the self-discharging loop.

8. The self-discharging method of claim 7, wherein the self-discharging loop has a switch which allows or ceases the battery device to perform self-discharging under the control of the control circuit.

9. The self-discharging method of claim 7, wherein the self-discharging loop provides one of the functions of self-discharging and voltage-detection according to the state of a switch controlled by the control circuit.

10. The self-discharging method of claim 7, wherein the self-discharging loop provides one of the functions of self-discharging and pre-charging according to the state of a switch controlled by the control circuit.
